(19) United States
(12) Patent Application Publication
(10) Pub. No.: US 2026/0339824 A1
(43) Pub. Date: Oct. 29, 2026

(54) AUTOMATIC CODE GENERATION AND TESTING

(71) Applicant: Microsoft Technology Licensing, LLC, Redmond, WA (US)

(72) Inventors: Daniel Lee MACE, Bellevue, WA (US); Naveed Azeemi AHMAD, Medford, MA (US); Max PIASEVOLI, New York, NY (US); Quang Minh NGUYEN, Redmond, WA (US); Srisuma MOVVA, Seattle, WA (US); Andrew White WICKER, Fall City, WA (US); Yogesh Kant ROY, Redmond, WA (US); Kadri TAHSILDOOST, Bellevue, WA (US)

(21) Appl. No.: 19/193,346

(22) Filed: Apr. 29, 2025

(51) Int. Cl. G06F 11/3668; G06F 8/30

(52) U.S. Cl. CPC G06F 11/3684; G06F 8/30

(57) ABSTRACT

Systems, methods, and computer program products are disclosed for automatic code generation and testing. Metadata is determined for a dataset. Data processing code for processing data in the dataset is automatically generated based on the metadata. Test cases are automatically generated for testing the data processing code based on the first data processing code and a data sample generated based on the dataset. The data processing code is automatically executed based on the test cases to generate actual test results. The data processing code is validated by comparing the actual test results to expected test results associated with the test cases.

### BACKGROUND

A data processing pipeline is a series of processes that automate the flow of data from various data sources to a destination (e.g., data warehouse). Such a pipeline typically involves a data extraction stage where data is collected from various data sources, a transformation stage where the collected data is transformed, and a loading stage where the transformed data is stored for further analysis and/or processing. During the transformation stage, the collected data can be filtered based on criteria, normalized into a usable form, and/or enhanced with additional information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer program products are disclosed for automatically generating and testing code for a data processing pipeline. Code is automatically generated based on characteristics of collected data. The generated code is automatically tested to validate the code. The validated code is deployed to a data processing pipeline to automate the processing of collected data.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for automatically generating and testing code, in accordance with an embodiment.

FIG. 2 shows a block diagram of an example system for automatically generating and testing code using artificial intelligence (AI) agents, in accordance with an embodiment.

FIG. 3 shows a flowchart of an example process for automatically generating and testing code, in accordance with an embodiment.

FIG. 4 shows a flowchart of an example process for automatically generating code using an AI agent, in accordance with an embodiment.

FIG. 5 shows a flowchart of an example process for automatically generating test cases using an AI agent, in accordance with an embodiment.

FIG. 6 depicts a flowchart of an example process for automatically regenerating code using an AI agent based on validation feedback, in accordance with an embodiment.

FIG. 7 shows a flowchart of an example process for generating synthetic data for a dataset, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A data processing pipeline is a series of automated processes that move and transform data from a data source to a destination for storage, analysis, or further processing. A data processing pipeline typically processes data in stages. In an example pipeline with three stages, data is extracted or collected from various data sources in the first stage. In the second stage, the collected data is transformed into a usable form by, for example, filtering the data, normalizing the data and/or enhancing the data. Data filtering employs criteria (e.g., value-based filtering) to selectively include or exclude data to ensure that relevant or desired data moves forward in the data processing pipeline for further processing. Such data normalization entails reorganizing the data into a standardized data format. Data enhancement entails enriching the data with additional information from other data sources. In the third stage, the transformed data is loaded to a destination for storage, analysis, and/or further processing.

In some instances, stages of a data processing pipeline are automated using ETL (Extract Transform Load) code. ETL code varies based on the characteristics of the collected data. As used herein, a characteristic is a quality or feature of the data. Examples of a characteristic include a data size (e.g., number of records), a data type (e.g., number, string, Boolean), a schema, a primary key, a foreign key, and a data format. Due to variations in data collected from various data sources, ETL code can vary significantly from one data source to another data source. Furthermore, traditional techniques for generating ETL code require significant input from developers who have highly-specialized knowledge to avoid errors in the ETL code. For example, subject matter experts may first analyze data sources to determine their characteristics (e.g., input schema, data type, etc.), determine an output schema based on a desired target or output ontology, and subsequently generate the ETL code based on the determined characteristics of the data sources and the output schema. Such techniques result in rigid workflows that are difficult to scale or are not scalable at all. Further issues arise due to the developer-generated ETL code typically being incompatible with evolving data sources, and repeated intervention is required to generate additional ETL code as new data sources are encountered and/or schemas change.

Embodiments disclosed herein overcome these issues. In particular, embodiments disclosed herein are directed to the use of one or more artificial intelligence (AI) agents to automatically generate and test ETL code. An AI agent is a system or program that autonomously performs a task on behalf of a user or another system. An AI agent can be implemented using various techniques, such as, but not limited to, machine learning, deep learning, and natural language processing. A first AI-agent is employed to analyze collected data to determine characteristics of the collected data. The collected data and other relevant contextual information are provided to a second AI-agent that generates the ETL code. The generated ETL code and a sample of the collected data are provided to a third AI-agent that generates test cases for testing the generated ETL code. While three AI-agents are described above, in other configurations, fewer or more AI-agents may be employed to implement aspects disclosed herein. The generated ETL code is automatically validated (its accuracy checked) with the generated test cases that pair an input value (e.g., data sample) and an expected output value. Validation is the process of confirming that the code functions as expected. The ETL code is validated by executing the ETL code with the input value to generate an output value, and comparing the generated output value to the expected output value. Upon successful validation, the generated ETL code can be integrated into the data processing pipeline to automatically process collected data.

The process of code generation and testing has various advantages. For instance, the process can leverage AI agents that can analyze information across knowledge areas, including, for example, security table domain knowledge, ontology and normalization best practices, and code generation. The process iteratively generates and tests ETL code to improve the ETL in a subsequent iteration based on testing feedback from a prior iteration. Additionally, this process is less error-prone than code generated and tested using traditional techniques. Furthermore, by this process allows ETL code to be easily regenerated and tested, thereby enabling greater scalability and handling of evolving data sources by the automatic generation of new code directed to the increased input data set sizes and different, evolving types of data sources.

Furthermore, in instances, such automatic generation and testing of code is iterated to generate even more improved code. For example, feedback generated during ETL code validation is provided to the second AI-agent to enable the second AI-agent to improve the ETL code. Feedback can include errors (e.g., compilation errors, runtime errors, etc.) that are encountered during validation, test case outcomes (e.g., pass, fail, etc.), and/or test case output. Compilation errors are provided as feedback to the second AI-agent to regenerate the ETL code to correct the encountered errors. Test case outcomes and/or outputs are provided to the second AI-agent to enable the second AI-agent to improve the correctness of the ETL code.

Further still, state information is maintained for iterations in the ETL code generation process. This maintaining of state information has the benefit of enabling the AI-agents to revert to a prior state in the ETL code generation process. Such state information is maintained in a data structure (e.g., tree, binary tree, directed acyclic graph (DAG), etc.) to track the ETL code generation process across iterations. During each subsequent ETL code generation iteration, a new node is added to the data structure. When an approach fails to improve the ETL code across iterations, a prior state in the ETL code generation process is determined by traversing the data structure, and the determined prior state is provided to the second AI-agent along with feedback on the failed approach to enable the second AI-agent to regenerate the ETL code using a different approach. As such, through this maintenance and application of state information, failed code generated based on a more recent state can be rejected, and code may be generated based on more reliable prior states. The use of state information to guide the ETL code generation process can be semi-automated based on user input. For instance, a human user can guide the process by selecting prior states to revert to and/or by providing additional feedback (e.g., in a textual prompt) to the AI-agents to guide the ETL code generation process.

Implementations for these and further embodiments are described in further detail as follows.

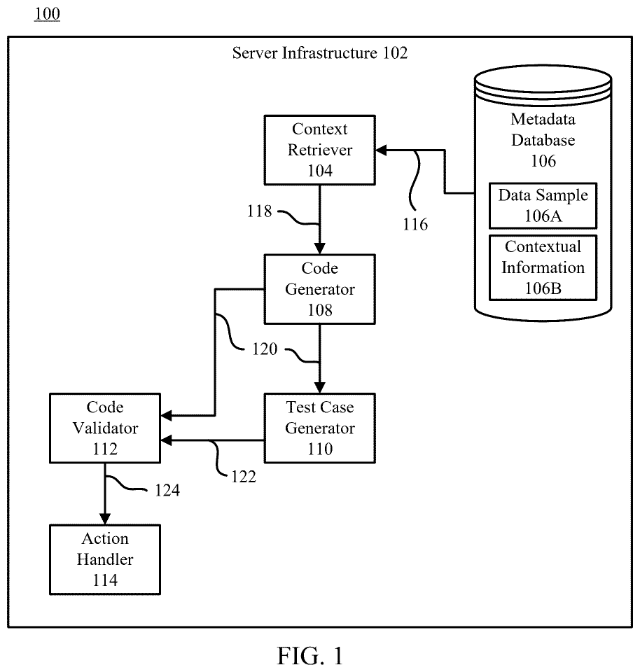

For example, FIG. 1 shows a block diagram of an example system 100 for automatically generating and testing code, in accordance to an embodiment. As shown in FIG. 1, system 100 includes a server infrastructure 102 that comprises a context retriever 104, a metadata database 106, a code generator 108, a test case generator 110, a code validator 112, and an action handler 114. System 100 includes an example three stage process for the automatic generating and testing of code, which is applicable to many code generation tasks, including the generation of code related to cybersecurity (e.g., firewalls, data encryption, key generation and management), cloud management, desktop and mobile applications, etc. System 100 is described in detail as follows.

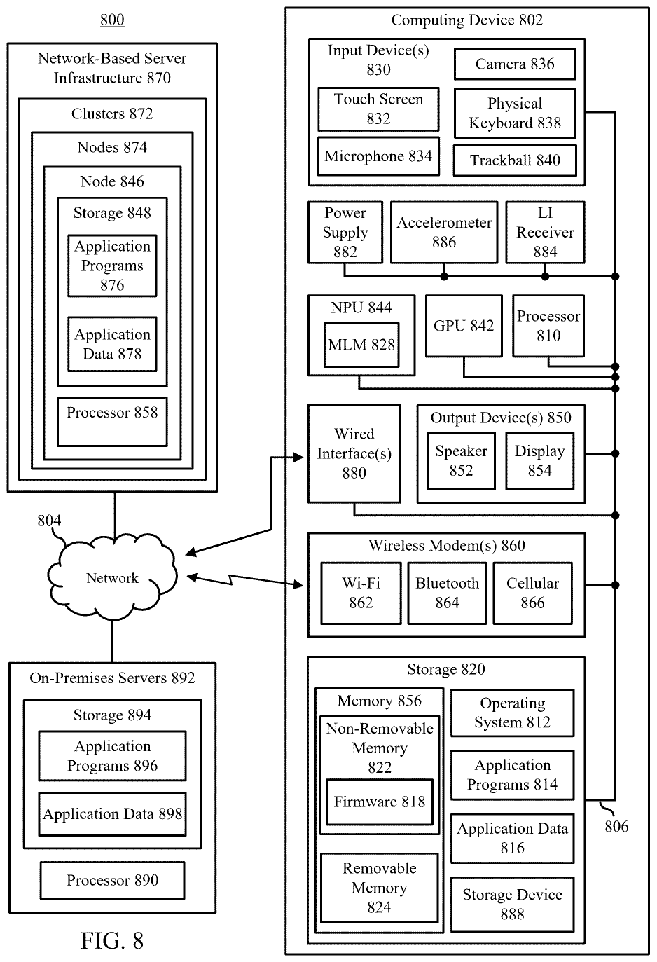

Server infrastructure 102 comprises a network-accessible server set (e.g., cloud-based environment or platform). In an embodiment, the underlying resources of server infrastructure 102 are co-located (e.g., housed in one or more nearby buildings with associated components such as backup power supplies, redundant data communications, environmental controls, etc.) to form a datacenter, are distributed across different regions, and/or are arranged in other manners. Various example implementations of server infrastructure 102 are described below in reference to FIG. 8 (e.g., network-based server infrastructure 870, on-premises server 892, and/or components thereof).

Context retriever 104 is configured to access metadata 116 associated with a dataset from metadata database 106. A dataset is a structured collection of data, such as a table, a file, and/or a database. Metadata is descriptive information about data. Examples of metadata include schema (e.g., column names, data types, relationships between tables, primary keys, foreign keys, common value formats, value patterns, etc.), descriptive information (e.g., table name, tags, keywords, etc.), administrative metadata (e.g., creation date, permissions, version, etc.), data source, and/or file format. Data is a collection of values that convey information. Data can be expressed in various forms, including a numerical value (e.g., price, phone number, etc.), a string value (e.g., e-mail addresses, user identifiers, etc.), a Boolean value (e.g., On/Off, Valid/Invalid, etc.), and a temporal value (e.g., timestamp, date, etc.). In embodiments, context retriever 104 retrieves contextual information relevant to the generation of data processing code. Contextual information is circumstantial and/or surrounding facts regarding a subject. Contextual information as used herein is circumstantial and/or surrounding facts that augments a prompt to improve the response of an artificial intelligence (AI) model. Examples of contextual information relevant to the generation of data processing code include information related to data processing code (e.g., ETL code, etc.), domain-specific knowledge (e.g., information about a data table, information about a product, etc.) and information related to data processing code generation (e.g., ETL code generation, etc.). Context retriever 104 can retrieve contextual information from various sources, such as, but not limited to, a data processing knowledgebase, technical documentation, whitepapers, scholarly papers, databases, knowledge graphs, FAQs, search engines, Wikipedia, enterprise data sources, social media, and/or the Internet. A data processing knowledgebase is a centralized repository that stores information related to code generation. Context retriever 104 provides the retrieved metadata 116 and/or contextual information as retrieved information 118 to code generator 108.

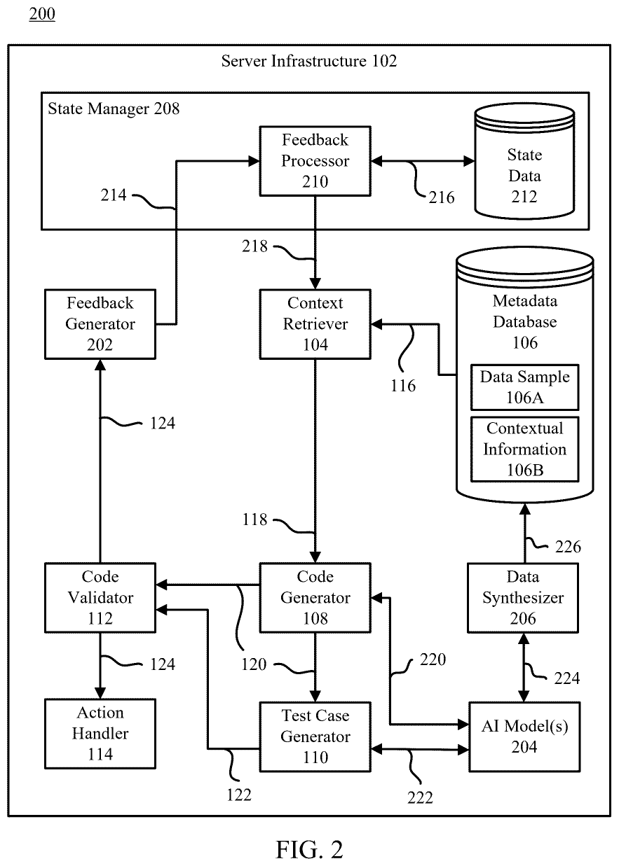

Metadata database 106 stores information associated with one or more datasets, such as, but not limited to, data samples 106A, contextual information, 106B, and metadata 116. In embodiments, data samples 106A include actual data samples extracted from a dataset, and/or synthetic data samples generated based on actual data from a dataset. In instances, contextual information 106B includes information relevant to data processing code generation. Metadata database 106 will be described in greater detail below in conjunction with FIG. 2.

Code generator 108 is configured to receive retrieved information 118 and generate data processing code 120. Data processing code is a computer program or script that automates extraction and transformation of information in a dataset. In embodiments, data processing code includes data filtering code, data normalization code, data enhancement code, and/or migration code. In configurations, code generator 108 is an AI-agent that employs artificial intelligence to generate data processing code 120. Code generator 108 provides data processing code 120 to test case generator 110 and/or code validator 112. Code generator 108 will be described in greater detail below in conjunction with FIG. 2.

Data filtering code is a computer program or script that filters values based on criteria. For instance, data filtering code can filter data collected from a data source based on a value of a particular datum (e.g., records for active users, records from a particular time period, records associated with a particular server, records for a specific type of event, etc.). Data filtering code can be used to filter a dataset based on a criteria (e.g., a logical expression) that determines whether a value in a record or entry of the dataset satisfies a value (e.g., date), a value range (e.g., a date range), or a pattern (e.g., regular expression, etc.). Data filtering code is useful for reducing the amount of data processing that needs to be performed for a large dataset by limiting downstream processing to data that is of interest. The data filtering code is also helpful for proper categorization of the data to ensure that the correct record types are output to the target or destination storage (e.g., table).

Data normalization code is a computer program or script that reorganizes information into a standardized format. For instance, data normalization code can convert a datum (e.g., a telephone number) from an input format (e.g., 2021234567) to a standardized format (e.g., +1 202-123-4567). Data normalization code ensures that data from diverse data sources are in a common format that enables the data to be directly compared.

Data enhancement code is a computer program or script that enriches a dataset with additional information from other data sources. Some specific examples of data enhancement code include code to add missing information (e.g., demographic information, network information, etc.), and/or code to map information (e.g., mapping IP address to geolocation, etc.). Data enhancement code improves the quality of a dataset by providing additional context to enhance data analysis. Data enhancement code can include code to join tables, and/or append external information (e.g., demographic details, geographic details).

Migration code is a computer program or script that transitions customer processes from a first system to a second system. For instance, migration code can include code for converting customer code that is compatible with a first system (e.g., legacy system) into code that is compatible with a second system (e.g., cloud system). This can include migration code for converting code from one programming language (e.g., C++, Python, etc.) to a second programming language (e.g., Java, JavaScript, etc.).

Test case generator 110 is configured to generate test cases 122 based at least on data processing code 120 received from code generator 108. A test case is a set of information designed to validate whether a computer program operates as expected. The set of information in a test case includes, for example, but not limited to, a test case identifier, a test case description, dependencies, test inputs, and/or expected test results. A test input is a value that is provided to a data processing code. An expected test result is an output value that is expected from the data processing code. A test case for testing data processing code 120 that, for example, normalizes and enhances a phone number datum may include a test input that is a phone number in a first format (e.g., 2021234567), and an expected output value of the phone number in a standardized format (e.g., +1 202-123-4567). In instances, an expected test result is determined without executing the data processing code. In embodiments, test case generator 110 generates test cases 122 based on data processing code 120, a data sample generated based on the dataset, and contextual information relevant to test case generation. A data sample is a subset of information that is representative of a dataset as a whole. Some specific examples of a data sample include a subset of data extracted (e.g., randomly) from a dataset, and/or synthetic data generated based on a subset of data extracted from a dataset. Synthetic data is fake or made-up information that is automatically or manually generated to mimic information in a dataset. Contextual information relevant to the test case generation include, for example, but not limited to, a knowledgebase, technical documentation, whitepapers, scholarly papers, databases, knowledge graphs, FAQs, search engines, Wikipedia, enterprise data sources, and/or other data sources related to test case generation. In configurations, test case generator 110 is an AI-agent that employs artificial intelligence to generate test cases 122. Test case generator 110 provides test cases 122 to code validator 112. Test case generator 110 will be described in greater detail below in conjunction with FIG. 2.

Code validator 112 is configured to perform automated validation of data processing code 120 using test cases 122. In embodiments, code validator 112 employs computer tools (e.g., scripts or build tools) to automatically compile data processing code 120 into an executable (e.g., binary code, machine code) using dependencies specified by test cases 122. Code validator 112 determines compile errors (e.g., syntax errors, dependency errors, etc.) that are returned by the compiler. A compilation error is an error that occurs during the process generating executable code. Some specific examples of compilation errors include syntax errors, type errors, undeclared variables, incorrect method calls (e.g., wrong number and/or types of parameters, etc.), and/or missing dependencies. Once compiled, into an executable, code validator 112 employs computer code (e.g., script) to run the executable using the test input specified in test cases 122 to generate actual results. During runtime, code validator 112 determines whether data processing code 120 completes execution and whether any runtime errors occur. A runtime error is an error that occurs during execution of code. Some specific examples of runtime errors include null pointer errors, type mismatch errors, memory leaks, and/or stack overflow errors. In embodiments, code validator 112 performs output schema validation on data processing code 120 to ensure that the required fields of an output schema (e.g., JSON schema) are defined, and that the actual test results (e.g., output data) have the correct data type and/or format. Code validator 112 compares the actual test results to expected test results in test cases 122. An actual test result is an output determined by executing the data processing code. Returning to the example test case provided above, an actual test result is determined by executing data processing code 120 using the test input (e.g., 2021234567), and includes a phone number in a second format (e.g., 202-123-4567). Comparing the actual test result (e.g., 202-123-4567) to the expected test result (e.g., +1 202-123-4567), code validator 112 can determine whether data processing code is operating as expected. A discrepancy (e.g., missing country code) between the actual test result and the expected test result can indicate that data processing code 120 is not operating as expected, and that data processing code 120 may need to be regenerated. Code validator 112 determines a validation result 124 based on an execution outcome (e.g., compilation error, runtime error, successful execution, etc.) of data processing code 120 and/or an execution result (e.g., whether actual test results match expected test results) of data processing code 120. Code validator 112 provides validation result 124 to action handler 114.

Action handler 114 is configured to perform a responsive action based on validation result 124 received from code validator 112. Responsive actions include, for example, but are not limited to, outputting data processing code 120 to a user interface, outputting test cases 122 to a user interface, outputting an execution outcome of data processing code 120 to a user interface, outputting an execution result of data processing code 120 to a user interface, outputting a user interface to enable a user to guide automated code generation, and/or deploying data processing code 120 to a data processing pipeline. In instances, action handler 114 automatically deploys data processing code 120 to the data processing pipeline upon successful validation of data processing code 120.

Embodiments described herein may operate in various ways to automatically generate and test code using AI agents. For instance, FIG. 2 shows a block diagram of an example system 200 for automatically generating and testing code using AI agents, in accordance with an embodiment. As shown in FIG. 2, system 200 includes server infrastructure 102, context retriever 103, metadata database 106, code generator 108, test case generator 110, code validator 112, and action handler 114. In system 200, server infrastructure 102 further includes a feedback generator 202, one or more AI models 204, a data synthesizer 206, and a state manager 208. In system 200, state manager 208 further includes a feedback processor 210, and state data 212. System 200 is described in further detail as follows.

Feedback generator 202 is configured to analyze validation results 124 received from code validator 112, and generate validation feedback 214. Validation feedback is information indicative of whether data processing code 120 operates as expected. Examples of validation feedback 214 include an error (e.g., compilation error, runtime error, etc.), a locations of the error (e.g., line number, etc.), an execution outcome (e.g., whether data processing code 120 completes execution), and/or an execution result (e.g., actual test result, whether the actual test result matches an expected test result, etc.). In embodiments, feedback generator 202 analyzes error (e.g., compiler error, runtime error, etc.) received from code validator 112 to determine the type of error, and the location of the error. For instance, feedback generator 202 can parse the text of an error generated by a compiler to determine the type of compiler error (e.g., type mismatch, syntax error, etc.), and the location (e.g., line number) of the error in the source code. Similarly, feedback generator 202 can parse the text of an error generated by a runtime engine to determine the type of runtime error (e.g., NULL pointer error, memory error, etc.), and the location (e.g., line number) of the error in the source code.

AI model(s) 204 are computational systems designed to simulate aspects of human intelligence by recognizing patterns in data and making predictions based on the patterns. Examples of AI model(s) 204 include small language models (SLM), medium language models (MLM), large language models (LLM), reasoning models, large reasoning models (LRM), advanced generative models, statistical models, and neural network-based models. Language models are artificial intelligence systems that are trained on textual data to process natural language inputs and generate outputs based on the natural language inputs. Various example implementations of AI model(s) 204 are described below in reference to FIG. 8 (e.g., MLM 828, and/or components thereof).

In embodiments, code generator 108 exchanges one or more first communications 220 with AI model(s) 204 to generate data processing code 120. For instance, code generator 108 provides, to AI model(s) 204, a first prompt comprising retrieved information 118 and requesting the generation of data processing code 120 based on retrieved information 118. A prompt is a piece of text provided to an AI model to guide its response or behavior. An example first prompt includes, for example, the text “Please generate data normalization code for a dataset having the following metadata based on the following contextual information” along with retrieved information 118. Code generator 108 receives a first response from AI model(s) 204 that includes data processing code 120. In instances, code generator 108 provides, to AI model(s) 204, a second prompt comprising retrieved information 118 and feedback 218 to request the regeneration of data processing code 120 based on retrieved information 118 and feedback 218. An example second prompt includes, for example, the text “Please regenerate data normalization code for a dataset having the following metadata based on the following contextual information and the following validation feedback” along with retrieved information 118 and feedback 218. Code generator 108 receives a second response from AI model(s) 204 that includes regenerated data processing code 120. In embodiments, AI model(s) 204 employed by code generator 108 may be the same and/or different than those employed by test case generator 110 and/or data synthesizer 206.

In instances, test case generator 110 exchanges one or more second communications 222 with AI model(s) 204 to generate test cases 122. For instance, test case generator 110 provides, to AI model(s) 204, a prompt comprising data processing code 120, a data sample generated based on the dataset, and contextual information related to test case generation to request the generation of test cases 122 based on the contextual information. An example prompt includes, for example, the text “Please generate test cases to test the following code for a dataset represented by the following data sample based on the following contextual information” along with data processing code 120, the data sample, and the contextual information. Test case generator 110 receives a response from AI model(s) 204 that includes test cases 122. In embodiments, AI model(s) 204 employed by test case generator 110 may be the same and/or different than those employed by code generator 108 and/or data synthesizer 206.

Data synthesizer 206 is configured to generate synthetic data that is representative of a dataset as a whole. In configurations, data synthesizer exchanges one or more third communications 224 with AI model(s) 204 to generate the synthetic data. For instance, data synthesizer 206 provides, to AI model(s) 204, a first prompt to request generation of metainformation associated with a dataset based on a sample of the dataset, and receives, from AI model(s) 204, a first response that includes the metainformation. An example first prompt includes, for example, the text “Please generate metainformation for a dataset having the following sample data” along with the sample of the dataset. Metainformation is descriptive information about a dataset. Some specific examples of metainformation include the schema (e.g., column names, data types, relationships between tables, primary keys, foreign keys, etc.), descriptive information (e.g., table name, tags, keywords, etc.), and/or file format. In embodiments, the metainformation for a dataset may be the same and/or different than metadata 116 associated with the dataset. Data synthesizer 206 provides, to AI model(s) 204, a second prompt comprising the metainformation to request generation of synthetic data based on the metainformation, and receives, from AI model(s) 204, a second response that includes the synthetic data. An example second prompt includes, for example, the text “Please generate synthetic data for a dataset based on the following metainformation” along with the metainformation. Data synthesizer 206 provides, to AI model(s) 204, a third prompt comprising the synthetic data to request generation of a searchable description of the dataset, and receives, from AI model(s) 204, a third response that includes a searchable description of the dataset. A searchable description is a natural language text that defines characteristics of the dataset. An example third prompt includes, for example, the text “Please generate a searchable description of a dataset having the following data” along with synthetic data. Data synthesizer 206 provides the metainformation, the synthetic data, and/or the searchable description, as metadata 226, to metadata database 106 for storage thereon. In embodiments, AI model(s) 204 employed by data synthesizer 206 may be the same and/or different than those employed by code generator 108 and/or test case generator 110.

State manager 208 is configured to maintain state information 216 related to the generation and/or testing of data processing code 120. State information is the data and status of the generation and testing of data processing code 120. In instances, state information 216 includes metadata 116, retrieved information 118, data processing code 120, test cases 122, validation results 124, validation feedback 214, first communication(s) 220, and/or second communications(s) 222. State manager 208 stores state information 216 in state data 212 using a data structure, such as, but not limited to, a tree data structure. In embodiments, state manager 208 adds a new node to the tree data structure after a code generation and testing iteration that includes state information 216 associated with the code generation and testing iteration. State manager 208 adds the new node along a path in the tree data structure that represents a code generation approach associated with the code generation and testing iteration.

Feedback processor 210 is configured to process validation feedback 214 received from feedback generator 202 and update state data 212 with state information 216. After a code generation and testing iteration, feedback processor 210 determines whether data processing code 120 generated during the latest iteration improves upon data processing code 120 generated during a previous iteration. For instance, feedback processor 210 determines whether an error (e.g., compilation error, runtime error, etc.) from the previous iteration has been resolved in the latest iteration, and/or whether test cases 122 with failed outcomes and/or results during the previous iteration have a passing outcome and/or result in the latest iteration. When feedback processor 210 determines that data processing code 120 has not improved over a predetermined number (e.g., one, two, etc.) iterations, feedback processor 210 retrieves state information 216 associated with a previous state from state data 212, and reverts the code generation process to the previous state by providing the retrieved state information 216 associated with the previous state as feedback 218 to context retriever 104 to cause code generator 108 to try a different approach. The predetermined number of iterations can be determined in various ways, including, but not limited to, by a subject matter expert, based on user input, and/or the like. In embodiments, feedback processor 210 determines a previous state by traversing the tree data structure along a path representing a current approach a predetermined number (e.g., three, five, etc.) nodes. The number of nodes traversed can be determined in various ways, including, but not limited to, by a subject matter expert, based on user input, and/or the like. When feedback processor 210 determines that data processing code 120 generated in the latest iteration improves upon data processing code 120 generated during a previous iteration, feedback processor 210 provides validation feedback 214 as feedback 218 to context retriever 104 to cause code generator 108 to regenerate data processing code 120 based on validation feedback 214.

State data 208 stores state information 216 in a data structure. In embodiments, state information 216 is stored in state data 212 in a tree data structure, where a node in the tree data structure represents a code generation and testing iteration and is associated with state information 216 from the code generation and testing iteration. In instances, a path in the tree data structure starting from a root node and following child nodes to a leaf node represents a code generation approach, where different paths through the tree data structure represent different code generation approaches.

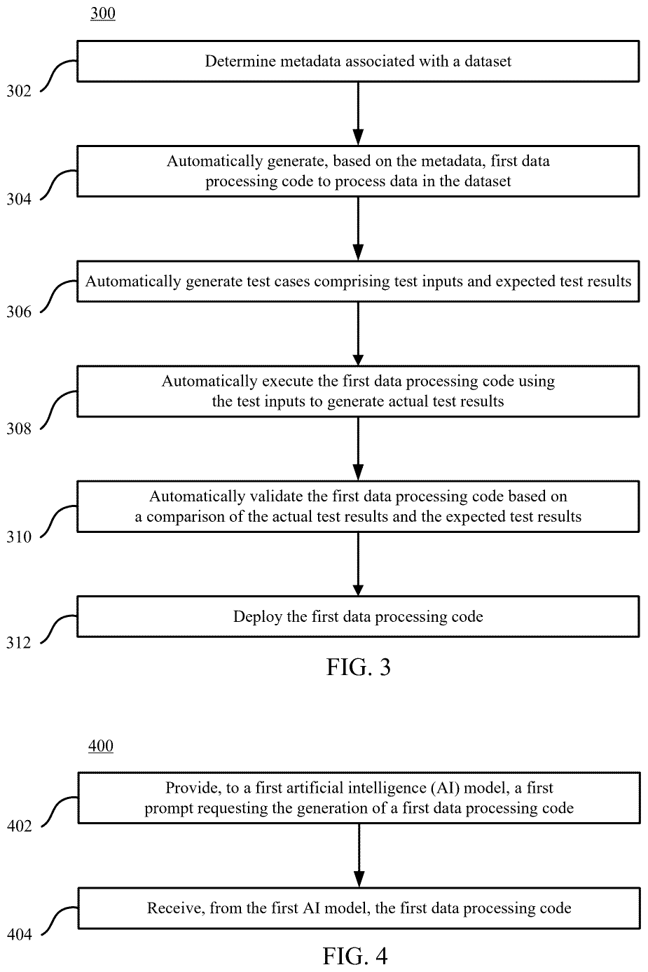

Embodiments described herein may operate in various ways to automatically generate and test code. For instance, FIG. 3 depicts a flowchart 300 of a process for automatically generating and testing code, in accordance with an embodiment. In embodiments, server infrastructure 102, context retriever 104, code generator 108, test case generator 110, code validator 112, and/or action handler 114 may, for example, operate according to flowchart 300. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, metadata associated with a dataset is determined. For instance, context retriever 104 determines metadata 116 associated with a dataset from metadata database 106. Context retriever 104 retrieves contextual information relevant to the generation of data processing code from various sources, such as, but not limited to, a data processing knowledgebase, technical documentation, whitepapers, scholarly papers, databases, knowledge graphs, FAQs, search engines, Wikipedia, enterprise data sources, social media, and/or the Internet. Context retriever 104 provides the retrieved metadata 116 and/or contextual information as retrieved information 118 to code generator 108.

In step 304, first data processing code to process data in the dataset is automatically generated based on the metadata. For instance, code generator 108 generates data processing code 120 based on retrieved information 118. Code generator 108 provides, to AI model(s) 204, a first prompt comprising retrieved information 118 to request the generation of data processing code 120 based on retrieved information 118, and receives a first response from AI model(s) 204 that includes data processing code 120. Code generator 108 provides data processing code 120 to test case generator 110 and/or code validator 112.

In step 306, test cases comprising test inputs and expected test results are automatically generated. Test case generator 110 provides, to AI model(s) 204, a prompt comprising data processing code 120, a data sample generated based on the dataset, and contextual information related to test case generation to request the generation of test cases 122, and receives a response from AI model(s) 204 that includes test cases 122. Test cases 122 comprise test inputs and expected test results.

In step 308, the first data processing code is automatically executed using the test inputs to generate actual test results. For instance, code validator 112 executes data processing code 120 using input values in test cases 122 to generate actual results. In an example implementation, code validator 112 employs computer code (e.g., a script) to automatically compile data processing code 120 into an executable (e.g., binary code, machine code). Code validator 112 then employs computer code (e.g., a script) to automatically execute the executable based on the test cases 122 by running the executable with test inputs specified by test cases 122.

In step 310, the first data processing code is automatically validated based on a comparison of the actual test results and the expected test results. For instance, code validator 112 determines actual test results from the execution of data processing code 120 using the test values specified by test cases 122, and compares the actual test results to expected test results in test cases 122. Returning to the example test case provided above, code validator 112 executes data processing code 120 using the test input (e.g., 2021234567) to determine the actual test result (e.g., 202-123-4567), and compares the actual test result (e.g., 202-123-4567) to the expected test result (e.g., +1 202-123-4567). In this example scenario, the actual test result differs from the expected test result in that the actual test result is missing the country code (e.g., +1). This discrepancy indicates that data processing code 120 is not operating as expected.

In step 312, the first data processing code is deployed. For instance, action handler 114 deploys data processing code 118 to a data processing pipeline based on validation result 124. When validation result 124 indicates that data processing code 118 is operating as expected, action handler 114 deploys data processing code 118 to a data processing pipeline to automatically process data.

Embodiments described herein may operate in various ways to automatically generate code using an AI agent. For instance, FIG. 4 depicts a flowchart 400 of a process for automatically generate code using an AI agent, in accordance with an embodiment. In embodiments, server infrastructure 102, code generator 108, and/or AI model(s) 204 may, for example, operate according to flowchart 400. Flowchart 400 is described as follows with respect to FIGS. 1 and 2 for illustrative purposes.

Flowchart 400 starts at step 402. In step 402, a first prompt requesting the generation of a first data processing code is provided to a first AI model. For instance, code generator 108 provides, to AI model(s) 204, a first prompt comprising retrieved information 118 and requesting the generation of data processing code 120 based on retrieved information 118. An example first prompt includes, for example, the text “Please generate data normalization code for a dataset having the following metadata based on the following contextual information” along with retrieved information 118.

In step 404, the first data processing code is received from the first AI model. For instance, code generator 108 receives a first response from AI model(s) 204 that includes data processing code 120.

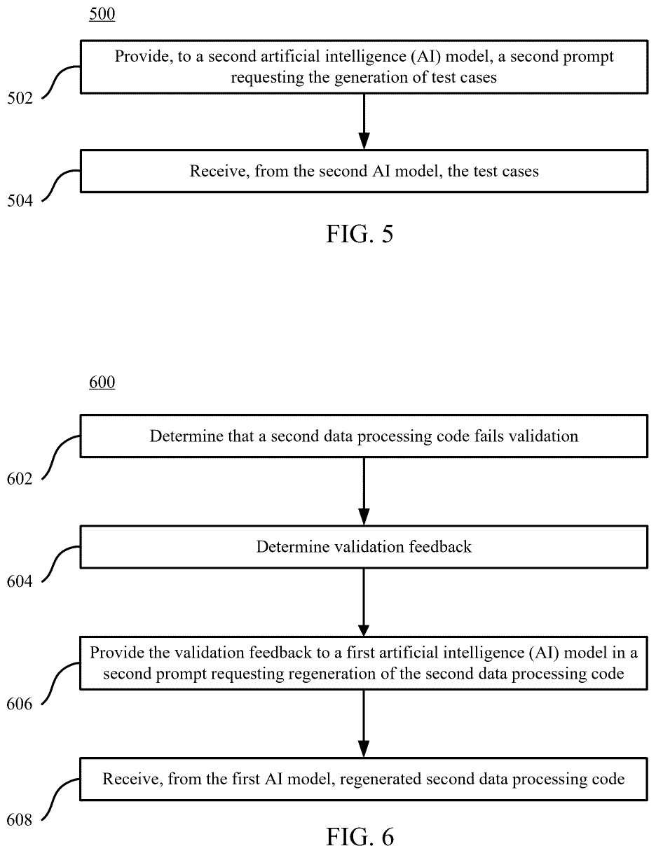

Embodiments described herein may operate in various ways to automatically generate test cases using an AI agent. For instance, FIG. 5 depicts a flowchart 500 of a process for automatically generating test cases using an AI agent, in accordance with an embodiment. In embodiments, server infrastructure 102, test case generator 110, and/or AI model(s) 204 may, for example, operate according to flowchart 500. Flowchart 500 is described as follows with respect to FIGS. 1 and 2 for illustrative purposes.

Flowchart 500 starts at step 502. In step 502, a second prompt requesting the generation of test cases is provided to a second AI model. For instance, test case generator 110 provides, to AI model(s) 204, a prompt comprising data processing code 120, a data sample generated based on the dataset, and contextual information related to test case generation to request the generation of test cases 122 based on the contextual information. An example prompt includes, for example, the text “Please generate test cases to test the following code for a dataset represented by the following data sample based on the following contextual information” along with data processing code 120, the data sample, and the contextual information.

In step 504, the test cases are received from the second AI model. For instance, test case generator 110 receives a response from AI model(s) 204 that includes test cases 122.

Embodiments described herein may operate in various ways to automatically regenerate code using an AI agent based on validation feedback. For instance, FIG. 6 depicts a flowchart 600 of a process for automatically regenerating code using an AI agent based on validation feedback, in accordance with an embodiment. In embodiments, server infrastructure 102, code generator 108, code validator 112, AI model(s) 204, feedback generator 202, and/or feedback processor 210 may, for example, operate according to flowchart 600. Note that not all steps of flowchart 600 may need to be performed in all embodiments, and in some embodiments, the steps of flowchart 600 may be performed in different orders than shown. Flowchart 600 is described as follows with respect to FIGS. 1 and 2 for illustrative purposes.

Flowchart 600 starts at step 602. In step 602, a second data processing code is determined to fail validation. For instance, code validator 112 executes data processing code 120 using input values in test cases 122, and determines that data processing code 120 fails validation. Code validator 112 determines that data processing code 120 fails validation based on errors (e.g., compilation errors, runtime errors, etc.) encountered during validation, and/or the actual test results not matching the expected test results in test cases 122.

In step 604, validation feedback is determined. For instance, code validator 112 and/or feedback generator 202 determine, as validation feedback 214, the errors (e.g., compilation errors, runtime errors, etc.) encountered during validation, error codes associated with the encountered errors, the location (e.g., line number, etc.) of the encountered errors, errors encountered during output schema validation, the actual test results, and/or the expected test results in test cases 122.

In step 606, the validation feedback is provided to a first AI model in a second prompt requesting regeneration of the second data processing code. For instance, validation feedback 214 is provided, as feedback 218, to AI model(s) 204 (via context retriever 104 and/or code generator 108) to request regeneration of data processing code 120. Code generator 108 provides, to AI model(s) 204, a second prompt comprising retrieved information 118 and feedback 218 to request the regeneration of data processing code 120 based on retrieved information 118 and feedback 218.

In step 608, regenerated second data processing code is received from the first AI model. For instance, code generator 108 receives a second response from AI model(s) 204 that includes regenerated data processing code 120.

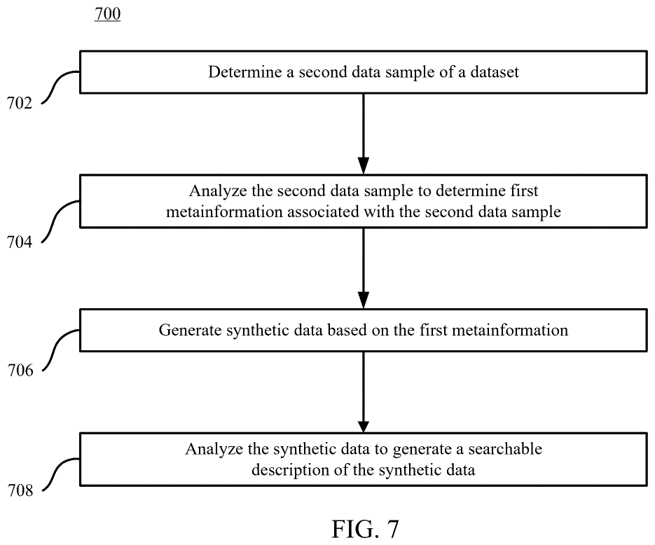

Embodiments described herein may operate in various ways to generate synthetic data for a dataset. For instance, FIG. 7 depicts a flowchart 700 of a process for generating synthetic data for a dataset, in accordance with an embodiment. In embodiments, server infrastructure 102, data synthesizer 206, and/or AI model(s) 204 may, for example, operate according to flowchart 700. Note that not all steps of flowchart 700 may need to be performed in all embodiments, and in some embodiments, the steps of flowchart 700 may be performed in different orders than shown. Flowchart 700 is described as follows with respect to FIGS. 1 and 2 for illustrative purposes.

Flowchart 700 starts at step 702. In step 702, a second data sample of a dataset is determined. For instance, data synthesizer 206 receives a sample of a dataset.

In step 704, the second data sample is analyzed to determine first metainformation associated with the second data sample. For instance, data synthesizer 206 provides, a prompt to AI model(s) 204 to request generation of metainformation associated with a dataset based on the sample of the dataset, and receives a response from AI model(s) 204 that includes the metainformation.

In step 706, synthetic data is generated based on the first metainformation. For instance, data synthesizer 206 provides a prompt to AI model(s) 204 comprising the metainformation to request generation of synthetic data based on the metainformation, and receives a response from AI model(s) 204 that includes the synthetic data.

In step 708, the synthetic data is analyzed to generate a searchable description of the synthetic data. For instance, data synthesizer 206 provides a prompt to AI model(s) 204 comprising the synthetic data to request generation of a searchable description of the dataset, and receives a response from AI model(s) 204 that includes a searchable description of the dataset.

### III. Example Mobile Device and Computer System Implementation

Server infrastructure 102, context retriever 104, metadata database 106, code generator 108, test case generator 110, code validator 112, action handler 114, feedback generator 202, AI model(s) 204, data synthesizer 206, state manager 208, feedback processor 210, state data 212, and/or the components described therein, and/or the steps of flowcharts 300, 400, 500, 600, and/or 700 are implemented in hardware, or hardware combined with one or both of software and/or firmware. For example, context retriever 104, metadata database 106, code generator 108, test case generator 110, code validator 112, action handler 114, feedback generator 202, AI model(s) 204, data synthesizer 206, state manager 208, feedback processor 210, state data 212, and/or the components described therein, and/or the steps of flowcharts 300, 400, 500, 600, and/or 700 are each implemented as computer program code/instructions configured to be executed in one or more processors and stored in a computer readable storage medium. Alternatively, server infrastructure 102, context retriever 104, metadata database 106, code generator 108, test case generator 110, code validator 112, action handler 114, feedback generator 202, AI model(s) 204, data synthesizer 206, state manager 208, feedback processor 210, state data 212, and/or the components described therein, and/or the steps of flowcharts 300, 400, 500, 600, and/or 700 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of server infrastructure 102, which each include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 can be any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing context retriever 104, metadata database 106, code generator 108, test case generator 110, code validator 112, action handler 114, feedback generator 202, AI model(s) 204, data synthesizer 206, state manager 208, feedback processor 210, state data 212, and/or each of the components described therein, as well as any of flowcharts 300, 400, 500, 600, 700, and/or any individual steps thereof.

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data that includes input features (attributes) and their corresponding output labels/target values (e.g., for supervised learning) is collected. A training algorithm is a computational procedure that is used so that MLM 828 learns from the training data. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features, and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operate application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

In embodiments, a system comprises: a processor; and a memory device comprising program code that is executed to cause the processor to: determine metadata associated with a dataset; automatically generate, based on the metadata, first data processing code to process data in the dataset; automatically generate, based on the first data processing code and a first data sample generated based on the dataset, test cases to validate the first data processing code, the test cases comprising test inputs and expected test results; automatically execute the first data processing code using the test inputs to generate actual test results; automatically validate the first data processing code based on a comparison of the actual test results and the expected test results; and deploy the first data processing code.

In embodiments, to automatically generate the first data processing code, the program code is executed by the processor to cause the processor to: provide, to a first artificial intelligence (AI) model, a first prompt requesting the generation of the first data processing code, the first prompt comprising the metadata and contextual information from a data processing knowledgebase; and receive, from the first AI model, the first data processing code.

In embodiments, the program code is executed by the processor to further cause the processor to: determine that a second data processing code fails validation; determine validation feedback; provide, to the first AI model, a second prompt requesting the regeneration of the second data processing code, the second prompt comprising the validation feedback; and receive, from the first AI model, regenerated second data processing code.

In embodiments, to determine the validation feedback, the program code is executed by the processor to further cause the processor to perform at least one of: determine a compile error associated with the second data processing code; determine an execution error associated with the second data processing code; determine a line of the second data processing code where an error associated with the second data processing code occurs; or determine that actual test results from execution of the second data processing code differs from expected test results in a test case associated with the second data processing code.

In embodiments, the first data processing code comprises at least one of: data filtering code to selectively exclude a portion of the dataset from further data processing; data normalization code to normalize the dataset into a normalized dataset; data enhancement code to enhance the dataset with supplementary information; or migration code to migrate data processing of the dataset from a first system to a second system.

In embodiments, the program code is executed by the processor to further cause the processor to: determine a second data sample of the dataset; analyze the second data sample to determine first metainformation associated with the second data sample; generate synthetic data based on the first metainformation; and analyze the synthetic data to generate a searchable description of the synthetic data, wherein the metadata associated with the dataset comprises at least one of the first metainformation, or the searchable description.

In embodiments, to automatically generate the test cases, the program code is executed by the processor to cause the processor to: provide, to a second AI model, a second prompt requesting the generation of the test cases, the second prompt comprising the first data processing code and the first data sample; and receive, from the second AI model, the test cases.

In embodiments, a method comprises: determining metadata associated with a dataset; automatically generating, based on the metadata, first data processing code to process data in the dataset; providing, to a first artificial intelligence (AI) model, a first prompt requesting the generation of the test cases, the first prompt comprising the first data processing code and a first data sample generated based on the dataset; receiving, from the first AI model, the test cases; automatically validating the first data processing code based on the test cases; and deploying the first data processing code.

In embodiments, automatically generating the first data processing code comprises: providing, to a second AI model, a second prompt requesting the generation of the first data processing code, the second prompt comprising the metadata and contextual information from a data processing knowledgebase; and receiving, from the second AI model, the first data processing code.

In embodiments, the method further comprises: determining that a second data processing code fails validation; determining validation feedback; providing, to the second AI model, a third prompt requesting the regeneration of the second data processing code, the third prompt comprising the validation feedback; and receiving, from the second AI model, regenerated second data processing code.

In embodiments, determining the validation feedback comprises at least one of: determining a compile error associated with the second data processing code; determining an execution error associated with the second data processing code; determining a line of the second data processing code where an error associated with the second data processing code occurs; or determining that actual test results from execution of the second data processing code differs from expected test results in a test case associated with the second data processing code.

In embodiments, the first data processing code comprises at least one of: data filtering code to selectively exclude a portion of the dataset from further data processing; data normalization code to normalize the dataset into a normalized dataset; data enhancement code to enhance the dataset with supplementary information; or migration code to migrate data processing of the dataset from a first system to a second system.

In embodiments, the method further comprises: determining a second data sample of the dataset; analyzing the second data sample to determine first metainformation associated with the second data sample; generating synthetic data based on the first metainformation; and analyzing the synthetic data to generate a searchable description of the synthetic data, wherein the metadata associated with the dataset comprises at least one of the first metainformation, or the searchable description.

In embodiments, automatically validating the first data processing code based on the test cases comprises: automatically executing the first data processing code using test inputs of the test cases to generate actual test results; and comparing the actual test results to expected test results of the test cases.

In embodiments, a computer-readable storage medium comprising executable instructions that are executed by a processor to cause the processor to: determine metadata associated with a dataset; provide, to a first artificial intelligence (AI) model, a first prompt requesting the generation of a first data processing code to process data in the dataset, the first prompt comprising the metadata and contextual information from a data processing knowledgebase; receive, from the first AI model, the first data processing code; automatically generate, based on the first data processing code and a first data sample generated based on the dataset, test cases to validate the first data processing code, the test cases comprising test inputs and expected test results; automatically execute the first data processing code using the test inputs to generate actual test results; automatically validate the first data processing code based on a comparison of the actual test results and the expected test results; and deploy the first data processing code.

In embodiments, the executable instructions are executed by the processor to further cause the processor to: determine that a second data processing code fails validation; determine validation feedback; provide, to the first AI model, a second prompt requesting the regeneration of the second data processing code, the second prompt comprising the validation feedback; and receive, from the first AI model, regenerated second data processing code.

In embodiments, determine validation feedback, the executable instructions are executed by the processor to cause the processor to perform at least one of: determine a compile error associated with the second data processing code; determine an execution error associated with the second data processing code; determine a line of the second data processing code where an error associated with the second data processing code occurs; or determine that actual test results from execution of the second data processing code differs from expected test results in a test case associated with the second data processing code.

In embodiments, the first data processing code comprises at least one of: data filtering code to selectively exclude a portion of the dataset from further data processing; data normalization code to normalize the dataset into a normalized dataset; data enhancement code to enhance the dataset with supplementary information; or migration code to migrate data processing of the dataset from a first system to a second system.

In embodiments, the executable instructions are executed by the processor to further cause the processor to: determine a second data sample of the dataset; analyze the second data sample to determine first metainformation associated with the second data sample; generate synthetic data based on the first metainformation; and analyze the synthetic data to generate a searchable description of the synthetic data, wherein the metadata associated with the dataset comprises at least one of the first metainformation, or the searchable description.

In embodiments, to automatically generate the test cases, the executable instructions are executed by the processor to cause the processor to: provide, to a second AI model, a second prompt requesting the generation of the test cases, the second prompt comprising the first data processing code and the first data sample; and receive, from the second AI model, the test cases.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system comprising:
a processor; and
a memory device comprising program code that is executed to cause the processor to:
determine metadata associated with a dataset;
automatically generate, based on the metadata, first data processing code to process data in the dataset;
automatically generate, based on the first data processing code and a first data sample generated based on the dataset, test cases to validate the first data processing code, the test cases comprising test inputs and expected test results;
automatically execute the first data processing code using the test inputs to generate actual test results;
automatically validate the first data processing code based on a comparison of the actual test results and the expected test results; and
deploy the first data processing code.

2. The system of claim 1, wherein, to automatically generate the first data processing code, the program code is executed by the processor to cause the processor to:
provide, to a first artificial intelligence (AI) model, a first prompt requesting the generation of the first data processing code, the first prompt comprising the metadata and contextual information from a data processing knowledgebase; and
receive, from the first AI model, the first data processing code.

3. The system of claim 2, wherein the program code is executed by the processor to further cause the processor to:
determine that a second data processing code fails validation;
determine validation feedback;
provide, to the first AI model, a second prompt requesting the regeneration of the second data processing code, the second prompt comprising the validation feedback; and
receive, from the first AI model, regenerated second data processing code.

4. The system of claim 3, wherein, to determine the validation feedback, the program code is executed by the processor to further cause the processor to perform at least one of:
determine a compile error associated with the second data processing code;
determine an execution error associated with the second data processing code;
determine a line of the second data processing code where an error associated with the second data processing code occurs; or
determine that actual test results from execution of the second data processing code differs from expected test results in a test case associated with the second data processing code.

5. The system of claim 1, wherein the first data processing code comprises at least one of:
data filtering code to selectively exclude a portion of the dataset from further data processing;
data normalization code to normalize the dataset into a normalized dataset;
data enhancement code to enhance the dataset with supplementary information; or
migration code to migrate data processing of the dataset from a first system to a second system.

6. The system of claim 1, wherein the program code is executed by the processor to further cause the processor to:
determine a second data sample of the dataset;
analyze the second data sample to determine first metainformation associated with the second data sample;
generate synthetic data based on the first metainformation; and
analyze the synthetic data to generate a searchable description of the synthetic data,
wherein the metadata associated with the dataset comprises at least one of the first metainformation, or the searchable description.

7. The system of claim 1, wherein, to automatically generate the test cases, the program code is executed by the processor to cause the processor to:
provide, to a second AI model, a second prompt requesting the generation of the test cases, the second prompt comprising the first data processing code and the first data sample; and
receive, from the second AI model, the test cases.

8. A method comprising:
determining metadata associated with a dataset;
automatically generating, based on the metadata, first data processing code to process data in the dataset;
providing, to a first artificial intelligence (AI) model, a first prompt requesting the generation of the test cases, the first prompt comprising the first data processing code and a first data sample generated based on the dataset;
receiving, from the first AI model, the test cases;
automatically validating the first data processing code based on the test cases; and
deploying the first data processing code.

9. The method of claim 8, wherein automatically generating the first data processing code comprises:
providing, to a second AI model, a second prompt requesting the generation of the first data processing code, the second prompt comprising the metadata and contextual information from a data processing knowledgebase; and
receiving, from the second AI model, the first data processing code.

10. The method of claim 9, further comprising:
determining that a second data processing code fails validation;
determining validation feedback;
providing, to the second AI model, a third prompt requesting the regeneration of the second data processing code, the third prompt comprising the validation feedback; and
receiving, from the second AI model, regenerated second data processing code.

11. The method of claim 10, wherein said determining the validation feedback comprises at least one of:
determining a compile error associated with the second data processing code;
determining an execution error associated with the second data processing code;
determining a line of the second data processing code where an error associated with the second data processing code occurs; or
determining that actual test results from execution of the second data processing code differs from expected test results in a test case associated with the second data processing code.

12. The method of claim 8, wherein the first data processing code comprises at least one of:
data filtering code to selectively exclude a portion of the dataset from further data processing;
data normalization code to normalize the dataset into a normalized dataset;
data enhancement code to enhance the dataset with supplementary information; or
migration code to migrate data processing of the dataset from a first system to a second system.

13. The method of claim 8, further comprising:
determining a second data sample of the dataset;
analyzing the second data sample to determine first metainformation associated with the second data sample;
generating synthetic data based on the first metainformation; and
analyzing the synthetic data to generate a searchable description of the synthetic data,
wherein the metadata associated with the dataset comprises at least one of the first metainformation, or the searchable description.

14. The method of claim 8, wherein automatically validating the first data processing code based on the test cases comprises:
automatically executing the first data processing code using test inputs of the test cases to generate actual test results; and
comparing the actual test results to expected test results of the test cases.

15. A computer-readable storage medium comprising executable instructions that are executed by a processor to cause the processor to:
determine metadata associated with a dataset;
provide, to a first artificial intelligence (AI) model, a first prompt requesting the generation of a first data processing code to process data in the dataset, the first prompt comprising the metadata and contextual information from a data processing knowledgebase;
receive, from the first AI model, the first data processing code;
automatically generate, based on the first data processing code and a first data sample generated based on the dataset, test cases to validate the first data processing code, the test cases comprising test inputs and expected test results;
automatically execute the first data processing code using the test inputs to generate actual test results;
automatically validate the first data processing code based on a comparison of the actual test results and the expected test results; and
deploy the first data processing code.

16. The computer-readable storage medium of claim 15, wherein the executable instructions are executed by the processor to further cause the processor to:
determine that a second data processing code fails validation;
determine validation feedback;
provide, to the first AI model, a second prompt requesting the regeneration of the second data processing code, the second prompt comprising the validation feedback; and
receive, from the first AI model, regenerated second data processing code.

17. The computer-readable storage medium of claim 16, wherein, to determine validation feedback, the executable instructions are executed by the processor to cause the processor to perform at least one of:
determine a compile error associated with the second data processing code;
determine an execution error associated with the second data processing code;
determine a line of the second data processing code where an error associated with the second data processing code occurs; or
determine that actual test results from execution of the second data processing code differs from expected test results in a test case associated with the second data processing code.

18. The computer-readable storage medium of claim 15, wherein the first data processing code comprises at least one of:
data filtering code to selectively exclude a portion of the dataset from further data processing;
data normalization code to normalize the dataset into a normalized dataset;
data enhancement code to enhance the dataset with supplementary information; or
migration code to migrate data processing of the dataset from a first system to a second system.

19. The computer-readable storage medium of claim 15, wherein the executable instructions are executed by the processor to further cause the processor to:
determine a second data sample of the dataset;
analyze the second data sample to determine first metainformation associated with the second data sample;
generate synthetic data based on the first metainformation; and
analyze the synthetic data to generate a searchable description of the synthetic data,
wherein the metadata associated with the dataset comprises at least one of the first metainformation, or the searchable description.

20. The computer-readable storage medium of claim 15, wherein, to automatically generate the test cases, the executable instructions are executed by the processor to cause the processor to:
provide, to a second AI model, a second prompt requesting the generation of the test cases, the second prompt comprising the first data processing code and the first data sample; and
receive, from the second AI model, the test cases.
